(19) United States
(12) Patent Application Publication
(10) Pub. No.: US 2026/0086341 A1
(43) Pub. Date: Mar. 26, 2026

(54) Microscope and Method for Microscopy

(71) Applicant: Carl Zeiss Microscopy GmbH, Jena (DE)

(72) Inventors: Richard Hollinger, Jena (DE); Ralf Netz, Jena (DE); Dirk Boonzajer Flaes, Jena (DE); Ingo Kleppe, Jena (DE); Ralf Proels, Tirschenreuth (DE); Joerg Siebenmorgen, Jena (DE)

(21) Appl. No.: 19/336,751

(22) Filed: Sep. 23, 2025

(30) Foreign Application Priority Data
Sep. 25, 2024 (DE) 10 2024 127 806.4

(51) Int. Cl. G02B 21/06; G01N 21/64; G02B 21/16; G02B 21/36

(52) U.S. Cl. CPC G02B 21/06; G01N 21/6458; G02B 21/16; G02B 21/361

(57) ABSTRACT

A microscope having a light source, an illumination beam path for guiding excitation light into a sample region, a detector for detecting emission light emitted by a sample, a detection beam path having a microscope objective for guiding the emission light onto the detector, and a control unit for evaluating emission light detected by the detector. The illumination beam path, for providing an intermediate image plane, comprises at least one relay optical unit, the illumination beam path comprises a multimode light guide, and an output end of the multimode light guide is arranged in the intermediate image plane or in the vicinity of the intermediate image plane.

The current application claims the benefit of German Patent Application No. 10 2024 127 806.4, filed on 25 Sep. 2024, which is hereby incorporated by reference.

The invention relates to a microscope according to the preamble of claim 1 and a method for microscopy according to the preamble of claim 25.

A generic microscope comprises at least the following constituent parts: a light source for providing excitation light, an illumination beam path for guiding the excitation light into a sample region, a two-dimensionally spatially resolving detector for detecting emission light emitted by a sample in the sample region, a detection beam path having a microscope objective for guiding the emission light onto the detector, and a control unit for evaluating emission light detected by the detector.

In a generic method, at least the following method steps are carried out: guiding excitation light from a light source via an illumination beam path onto a sample, guiding emission light emitted by the sample via a detection beam path having a microscope objective onto a two-dimensionally spatially resolving detector, and detecting the emission light by means of the detector.

Generic microscopes and generic methods are known in many configurations and variants, for example from [1].

For many microscopy techniques, the illumination of a region in a sample plane or of a region in a pupil plane with the most homogeneous, i.e. uniform, intensity distribution possible is desired. Such illumination modes are also referred to as flat-top illuminations.

A number of techniques for laser beam shaping are known which serve to shape an at least partially coherent homogeneous flat-top illumination from a spatially coherent Gaussian mode.

Firstly, there are techniques based on spatial trimming of the laser beam. Furthermore, techniques based on beam superimpositions or beam integrations are known. Finally, methods based essentially on beam redistributions have been described.

It is easy to realize a procedure in which, from a laser beam, those portions which have the desired intensity distribution are cut out. Since only a comparatively small portion of the light can be used in such techniques based on spatial trimming of the laser beam, these techniques are not often used. By way of example, the desired portion can be cut out from a Gaussian beam profile of a laser using a stop, for instance a mechanical component or a coated optical unit. Alternatively or supplementarily, a diffractive element can be used to cut out a desired beam profile from a Gaussian beam to be shaped. Desired and undesired portions of the Gaussian beam can be spatially separated from one another by means of a wedge-shaped phase of the diffractive element [Salter]. By spatially adapting the wedge-shaped phase pattern to the Gaussian beam to be shaped, the homogenization can be improved [Nakata]. Light outside the stop, i.e. outside the desired laser shape, is lost in this method and cannot be used. Owing to the high power losses, beam shaping by trimming the spatial beam profile is often impracticable.

In methods in which beam superimpositions and beam integrations are used, flat-top beam shaping is achieved by spatially splitting a beam and superimposing the individual constituent parts again in a smaller area by means of a focusing optical unit. By way of example, microlens arrays (MLA) can be used for this purpose. It is also possible to use reflective optical units. In that case, mirrors perform the function of the MLA.

Owing to the spatial superimposition of many partial beams, a flat wavefront and hence spatial coherence cannot be ensured in the case of such a beam shaping module. If coherent light is superimposed by means of such a beam shaping module, spotty structures arise owing to the interference. This is referred to in the jargon as “speckles” and speckled flat-tops.

Finally, beam shaping can also be achieved by means of multimode fibers by a procedure in which input coupling of a Gaussian mode, for example, into a multimode fiber results in the excitation of a plurality of spatial modes in the multimode fiber. Mode mixing in the multimode fiber gives rise, at the fiber end, to a beam profile shaped according to the fiber core. The superimposition of the individual optical modes once again gives rise to a speckled beam profile. In this case, a shape of the beam cross-section is given by the shape of the cross-section of the multimode fiber, in particular by the geometry of the light guiding core.

A reduction of the speckle structures, referred to as “despeckling”, is possible by way of rotating and/or wobbling diffusers. In the case of multimode fibers, wobbling can also be effected at the multimode fiber itself. Multimode fibers with an integrated despeckler are offered commercially by Molex [3]. The light at the end of the multimode fiber may be spatially incoherent or partially coherent. Instead of the multimode fiber, it is also possible to use light guiding rods, see for instance [2]. The flat-top beam profile arises in direct proximity to the exit region from the multimode fiber or the light guiding rod.

Cizmar et al. [Cizmar] have shown that the process of mode superimposition can be modeled and predicted with a high degree of accuracy. They have shown in particular that the individual modes, once coupled into a multimode fiber, do not couple strongly. Such modes are also called propagation invariant modes (PIMs), fiber modes or fiber eigenmodes. Speckles arise only if these modes move at different velocities. To a good approximation that is the case even if the fiber is curved. That in turn means that the excitation of only some of the modes leads to a speckle pattern having specific properties, independently of the fiber bending. These properties are dependent on the type of waveguide. Step-index waveguides have modes which correspond to different spatial frequencies. In other words, if the multimode light guide is excited by a beam which excites only a subset of the modes, this results in a beam with angular scattering corresponding to the angular scattering of the illumination. If the waveguide is excited in the middle of the waveguide with a limited numerical aperture, a speckled beam with a similar numerical aperture emerges. If the entering beam is coupled in at an angle, this typically leads to a ring-shaped angular distribution [Farley].

Beam shaping by way of redistribution can be achieved by an intensity distribution of an incoming Gaussian beam being redistributed by an optical unit such that the desired beam shape arises at the output. Such a redistribution of the light power can be achieved both by means of diffractive elements, i.e. for example by means of DOEs (diffractive optical elements) and/or by means of SLMs (spatial light modulators), and by means of refractive optical units, for example lenses. Laser beam modules based on beam redistribution by means of refractive optical units are commercially available from ADL-Optics, Berlin, [Stehr], and Asphericon, Jena [Khaw]. Diffractive optical units can be realized either in transmission, e.g. by means of transmissive SLMs or DOEs, or in reflection, e.g. by means of LCOS SLMs (Liquid Crystal on Silicon SLMs) or reflective DOEs, for instance from Midel Photonics.

A phase function required for converting a Gaussian beam into a desired shape can be determined for example using the Gerchberg-Saxton algorithm. However, this algorithm has the disadvantage that the phase after beam shaping is not flat, but rather chaotic. The phase can be corrected by means of a second phase element in a conjugate Fourier plane [Jesacher]. Moreover, algorithms that make it possible to reduce the speckles in holograms have been described [Schmidt]. These algorithms are comparatively complex and the luminous efficiency is rather unfavorable. Finally, it is possible for beam shapers to be integrally shaped onto the ends of light guiding fibers, for example using 3D printers [Printoptix, Schmidt, Plidschun].

Spatially coherent beam shaping can only be carried out by spatial trimming of a laser beam profile, by beam redistribution by means of refractive optical units and/or by a combination of two diffractive optical elements in optically conjugate Fourier planes. In this case, the spatial coherence relates to a flat phase of the shaped beam after beam shaping.

High-resolution is a term denoting microscopy methods in which a resolution better than the Abbe limit is possible. Besides methods based on laser scanning (e.g. STED (Stimulated Emission Depletion), RESOLFT (Reversible Saturable Optical Linear Fluorescence Transitions), MINFLUX (Minimal Fluorescence Photon Fluxes microscopy), Airyscan (Zeiss)), there are also methods based on wide-field illumination. The techniques relevant here include SIM (Structured light microscopy) and SMLM (Single Molecules Localization Microscopy) methods, which include for example PALM (Photo-Activated Localization Microscopy), (d) STORM ((direct) Stochastic Optical Reconstruction Microscopy) and PAINT (Points Accumulation In Nanoscale Topography).

The SIM method is based on structured illumination of a sample dyed with fluorescent dyes. It has proved to be practicable to use for this purpose the orders of diffraction of a phase grating produced e.g. in static fashion or by an SLM. The orders of diffraction of the grating are imaged as points into the pupil of the objective. In the sample plane, a grating structure is produced by interference of the beams. Only the lowest orders of diffraction of the grating are used. Alternatively, an amplitude grating can also be imaged into the sample plane. If incoherent light is used for SIM/Apotome, an amplitude grating must be used. Owing to the light losses at the amplitude grating, a phase grating is generally preferable. In order to obtain a high resolution image, the raw images have to be computed.

In the SMLM methods, wide-field illumination of the sample once again dyed with fluorescent dyes is carried out. Depending on the method, it is possible to initiate the blinking mechanism of molecules over different wavelengths (PALM), the intensity of the illumination (dSTORM) or the sample itself (PAINT).

The blinking results are detected and the fluorescence molecules can be localized by computer-based evaluation of the image data. In addition, TIRF (Total Internal Reflection Fluorescence) illumination can be used to avoid background interference and/or to achieve better sectioning. A realization of SMLM and TIRF using multimode fibers is described in [Lamm], [Kwakwa], [Ries]. That involves in each case imaging an angular spectrum of the multimode fibers into the sample plane. SIM using multimode fibers is described in [Gustafsson]. A TIRF method using rectangular multimode fibers, with the fiber end being arranged in a plane conjugate to the sample plane, is disclosed in US 2022/0326498 A1.

An object of the invention can be considered that of specifying a microscope and a method for microscopy in which a particularly well-defined illumination of the sample is possible.

This object is achieved by the microscope having the features of claim 1 and by the method having the features of claim 25.

The microscope of the type specified above is developed according to the invention by the features that the illumination beam path, for providing an intermediate image plane, comprises at least one relay optical unit, the illumination beam path comprises a multimode light guide, and an output end of the multimode light guide is arranged in the intermediate image plane or in the vicinity of the intermediate image plane, and the illumination beam path comprises a variable wavefront manipulation device arranged in an intermediate image plane or in the vicinity of an intermediate image plane.

The method of the type specified above is developed according to the invention by the features that an intensity distribution of the excitation light over a beam cross-section of the excitation light is homogenized by excitation light provided by the light source being guided via a multimode light guide, an output end of the multimode light guide being arranged in an intermediate image plane or in the vicinity of an intermediate image plane, and the excitation light, in particular for carrying out SIM methods, is manipulated by a variable wavefront manipulation device arranged in the illumination beam path in an intermediate image plane or in the vicinity of an intermediate image plane.

Preferred exemplary embodiments of the microscope according to the invention and advantageous variants of the method according to the invention are explained below, in particular in association with the dependent claims and the figures.

As a light source for the microscope according to the invention and the method according to the invention, in essence lasers are conceivable, but other light sources, for example LEDs, are also possible. For SIM, at least partially coherent light is generally preferred. The excitation light, which can also be referred to as illumination light, is electromagnetic radiation, preferably in the visible range and adjacent ranges. With regard to the samples to be examined, there is no restriction, in principle. The samples to be examined will often be biological samples.

The term illumination beam path denotes all optical beam-guiding and beam-modifying components, for example an illumination objective, lenses, mirrors, prisms, gratings, filters, stops, polarizers, beam splitters, modulators, for example spatial light modulators (SLM), by means of which and via which the excitation light from the light source is guided to the sample to be examined. Beam-modifying components also encompass dispersive and in particular diffractive elements. Commercially available microscope objectives can be used, in principle. Preferably, the excitation light is linearly polarized. For this purpose, by way of example, at least one polarizer can be present in the illumination beam path. The microscope objectives used preferably have high numerical apertures, for example numerical apertures of greater than 1, preferably greater than 1.4.

A spatial region on the object side of the illumination objective, in which a sample can be arranged, for example in a sample holder that is mounted on an x-y displacement stage, is also referred to as sample region within this description. In this sense, the terms sample and sample region are used synonymously.

The term intermediate image plane denotes a plane which is perpendicular, in particular with respect to the optical axis of the illumination beam path or of the detection beam path, and which is optically conjugate to an image plane of the respective microscope objective. The term pupil plane denotes a plane which is perpendicular, in particular with respect to the optical axis of the illumination beam path or of the detection beam path, and which is optically conjugate to a back focal plane of the respective microscope objective.

When the present description mentions that a component is situated in a pupil plane or in an intermediate image plane, that is always also taken to mean that the relevant component is situated in the vicinity of the respective pupil plane or in the vicinity of the respective intermediate image plane. That is already inherently clear anyway because neither the pupil planes nor the intermediate image planes are planes in the mathematical sense and because the components under consideration here, for example the spatial light modulators and lenses, each have a finite extent in the direction of the optical axis.

The two-dimensionally spatially resolving detector can be a CCD, CMOS or SPAD array camera, for example. Cameras that operate in an event-based mode can also be used.

The emission light emitted by the sample is electromagnetic radiation emitted by the sample illuminated with the excitation light. Emitting means that the detection light comes from the sample. The emission light can also be referred to as detection light. The emission light can be reflected back off the sample or can be light that is transmitted through the illuminated sample. In comparison with the excitation light, the emission light can typically be red-shifted fluorescence from fluorescent markers used to prepare the sample.

The term detection beam path denotes all beam-guiding and beam-modifying optical components, for example objectives, lenses, mirrors, prisms, gratings, filters, stops, beam splitters, polarizers, modulators, for example spatial light modulators (SLM), by means of which and via which the detection light is guided from the sample to be examined to the detector.

An illumination objective of the illumination beam path and the microscope objective of the detection beam path can be one and the same microscope objective. That may be the case for reflected-light microscopy, for example, in which the sample is illuminated and observed from one and the same direction. However, an illumination objective of the illumination beam path can also differ from that of the detection beam path. That is the case for example for transmitted-light microscopy and for reflected-light microscopy in which the sample is illuminated and observed obliquely, as in light sheet microscopy, for example.

The term control unit denotes all hardware and software components which interact with the components of the microscope according to the invention for the intended function thereof. In particular, the control unit can comprise a computing device, for example a PC, and a camera controller. The computer resources of the control unit can be distributed among a plurality of computers and optionally a computer network, in particular also via the Internet. The controller can have in particular customary operating devices and peripherals, such as mouse, keyboard, screen, storage media, joystick, Internet connection. The controller can in particular read the image data from the detector and can also be configured and serve to control the light source. The controller can for example also be configured to control spatial light modulators.

A flat-top region should be understood to mean a region having finite axial and finite lateral extent in the illumination beam path in which the illumination light has a substantially homogeneous lateral light distribution.

The term relay optical unit denotes an optical group used to realize an optical imaging, in particular a 4f imaging of a plane, in particular an intermediate image plane or a pupil plane, into a further intermediate image plane or a further pupil plane. By way of example, a relay optical unit can be formed by two lenses arranged at a distance from one another that corresponds to the sum of the focal lengths of the two lenses. By means of these two lenses, a first plane, for example a first intermediate image plane, which is situated on a side of the first lens which faces away from the second lens, and whose distance from the first lens corresponds to the focal length of the first lens, is optically imaged into a second plane, for example a second intermediate image plane, which is situated on a side of the second lens which faces away from the first lens, and whose distance from the second lens corresponds to the focal length of the second lens. The distance between the first intermediate image plane and the second intermediate image plane is then double the sum of the focal lengths of the two lenses, hence 4f.

The term multimode light guide denotes a light guide which is able to propagate a plurality of light modes, in contrast to single-mode fibers, for example, in which only a single mode per polarization direction can be propagated.

An essential concept of the invention can be considered that of generating a homogeneous light distribution, in particular of at least partially coherent light, using at least one multimode light guide, and arranging the latter in the illumination beam path in such a way that its output end lies in an intermediate image plane of the illumination beam path or in a vicinity of such a plane. The exit end of the multimode light guide is thus arranged in the illumination beam path in such a way that a critical illumination is realized.

A first major advantage of the invention can be considered to be that of being able to avoid the periodic modulations of the detected fluorescent light in tiled images of large sample regions, which modulations arise with the use of Gaussian illumination profiles on account of the drop in the illumination intensity at the edge of the image field, hence outside the maximum of the Gaussian profile. A second advantage of the invention is that the illumination light can in any case still be provided in a partially coherent fashion, such that in particular SIM is possible.

The method according to the invention can be carried out in particular by means of the microscope according to the invention, that is to say that the microscope according to the invention is used in advantageous variants of the method according to the invention. The microscope according to the invention can be configured in particular for carrying out the method according to the invention and/or variants thereof.

In principle, it is possible for the multimode light guide to be formed from a rigid component. By way of example, the multimode light guide can comprise at least one multimode light guiding rod. In preferred configurations of the microscope according to the invention and advantageous variants of the method according to the invention, at least one multimode fiber is used as multimode light guide. The multimode fiber can be in particular a step-index multimode fiber. Step-index multimode fibers are distinguished by the fact that the core has a higher refractive power than the cladding.

The term wavefront manipulation device denotes an optical device that changes a wavefront of light which passes through or which is reflected, specifically of the excitation light. Variable means that the wavefront manipulation device is changeable in some way, for example is controllable. Manipulating the excitation light means that a wavefront of the excitation light is changed in some way.

According to the invention, the excitation light, in particular for carrying out SIM methods, is manipulated by the variable wavefront manipulation device arranged in the illumination beam path in an intermediate image plane or in the vicinity of an intermediate image plane. For method variants in which the wavefront does not need to be manipulated, for example in SMLM methods, the variable wavefront manipulation device can be removed from the beam path or switched to an operating mode in which the light is not manipulated. A suitable controllable drive can expediently be present for this purpose.

The variable wavefront manipulation device can comprise for example at least one diffractive and/or at least one refractive component. The refractive component can comprise or be for example a laterally displaceable transmission grating and/or at least one laterally displaceable reflection grating. The transmission grating and/or the reflection grating can be a phase grating and/or an amplitude grating. A drive can be present for laterally displacing the transmission grating and/or the reflection grating. The term lateral directions should be understood here to mean such directions which run transversely or perpendicularly to the optical axis at the location of the grating. The control unit can expediently be configured for controlling the drive for laterally displacing the transmission grating or the reflection grating. Alternatively or supplementarily, the wavefront manipulation device can comprise at least one spatial light manipulator. The control unit can expediently be configured for controlling the spatial light manipulator or the spatial light manipulators. In principle, it is possible for the spatial light manipulator to be an amplitude-modulating spatial light manipulator. Owing to the lower light losses, however, preferably phase-modulating spatial light modulators are often used. The spatial light manipulator can be a reflective or a transmissive spatial light manipulator.

A spatial light modulator can also be used to carry out corrections and adaptations of the illumination beam path, for example to carry out adaptations to different microscope objectives, in particular a different axial pose of the respective back focal plane.

As described above, speckles, hence local deviations from homogeneity, may occur at the output end of the multimode light guide. One comparatively simple possibility for reducing such speckles is to use comparatively long multimode fibers. By way of example, it can be preferred to use multimode fibers having a length of more than 2 meters.

Another possibility for suppressing speckles involves moving at least one part of the multimode fiber back and forth in the illumination beam path. Since the geometry of the multimode fiber changes at least slightly during movement of said fiber, the composition of the optical modes propagated in the multimode fiber at the relevant points in time changes in each case. The result of that ultimately is that the light distribution at the exit end of the multimode fiber becomes more homogeneous. In order to realize that, the illumination beam path can advantageously comprise a device for mechanically manipulating the multimode fiber. By way of example, at least one part of the multimode fiber can be shaken or excited to effect vibrations in the illumination beam path. For this purpose, the device for mechanically manipulating the multimode fiber can comprise a device for shaking or vibrating the multimode fiber.

Good results with regard to the homogenization of the light distribution are attained for example if a frequency of the movement of a part of the multimode fiber, in particular of the vibrations, is greater than 500 Hz, preferably greater than 1 KHz.

Supplementarily or alternatively, in a further variant of the method according to the invention, the excitation light can be homogenized by means of a diffuser arranged downstream or upstream of the multimode light guide in the illumination beam path. The homogeneity of the light distribution of the excitation light can thus be increased in advantageous embodiments in which the illumination beam path comprises a diffuser downstream of the multimode light guide. Alternatively or supplementarily, the or a diffuser could also be arranged between the light source and the multimode light guide, i.e. upstream of the multimode light guide.

In this case, further improvements in homogeneity are possible if the diffuser is moved in the illumination beam path. A device for moving the diffuser is advantageously present for this purpose. By way of example, the diffuser can be moved back and forth in the illumination beam path. The device for moving the diffuser can comprise a wobbling device for this purpose. Alternatively or supplementarily, it is also possible for the diffuser to be rotated in the illumination beam path. For this purpose, the device for moving the diffuser can comprise a rotating device.

Finally, good results with regard to the homogeneity of the light distribution can also be achieved if the diffuser is put into an oscillating state, in particular relative to the output end of the multimode light guide. By way of example, the diffuser can be put into a state in which it oscillates back and forth, in particular relative to the output end of the multimode fiber, by means of the device for moving the diffuser.

In principle, it is possible for the multimode light guide to have a circular cross-section. That may be sufficient for recording individual images. However, since the camera chips of available cameras are generally rectangular or in any case not circular, the area of the camera chips cannot be optimally utilized if the illumination has a circular cross-section.

However, the cross-section of the multimode light guide can also have the shape of a polygon, in particular an equilateral polygon. By way of example, the cross-section of the multimode light guide can have the shape of a hexagon, in particular an equilateral hexagon. In particular, the use of multimode light guides having a rectangular or square cross-section may be preferred for recording tiled images.

In particularly preferred embodiment variants of the microscope according to the invention, a sensor area of the detector and a cross-sectional area of the multimode light guide have the same type of geometric shape.

By way of example, both the sensor area of the detector (95) and the cross-sectional area of the multimode light guide can each have a polygon shape, in particular a regular polygon shape, the shape of a regular hexagon, a rectangular shape or a square shape. It is also advantageous if the shape of the sensor area of the detector and the shape of the cross-sectional area of the multimode light guide are geometrically transformable into one another by a similarity mapping.

In one particularly preferred embodiment of the microscope according to the invention, the detection beam path is configured to image an illuminated area in the sample region into a sensor plane of the camera in such a way that a maximum overlap between a sensor region of the camera and the image of the illuminated area in the sample region is attained in the sensor plane. The excitation light provided at the exit end of the multimode light guide and the sensor region of the camera are thus utilized in the best possible way.

In preferred configurations of the microscope according to the invention, the illumination beam path comprises a device for varying an angle of incidence of the excitation light on the sample. Preferably, the angle of incidence of the excitation light can be adjustable between incidence of the excitation light parallel to the optical axis and incidence of the excitation light for which a TIRF condition is satisfied.

The device for varying the angle of incidence of the excitation light can comprise a pivotable mirror or a pivotable plane-parallel glass plate, said mirror or said plate being arranged in an intermediate image plane or in the vicinity of an intermediate image plane of the illumination beam path. A mechanical drive can be present for pivoting the pivotable mirror or the pivotable plane-parallel glass plate. The control unit can expediently be configured for controlling the mechanical drive for the pivotable mirror or the pivotable plane-parallel glass plate. Such a pivotable mirror is also referred to as a TIRF mirror.

Supplementarily or alternatively, the device for varying the angle of incidence of the excitation light can comprise a device for producing a variable lateral beam offset, said device being arranged in a pupil plane or in the vicinity of a pupil plane of the illumination beam path. The device for producing a variable lateral beam offset can comprise for example a double prism that is positionable laterally variably in the illumination beam path. A mechanical drive can be present for laterally adjusting the laterally variably positionable double prism. The control unit can expediently be configured for controlling the mechanical drive for the laterally variably positionable double prism. Such a device for producing a variable lateral beam offset is also referred to as a TIRF slider.

In advantageous variants of the method according to the invention, an HILO method (HILO=Highly Inclined and Laminated Optical sheet) is carried out.

Advantageously, at least one of the following methods can be carried out: SIM methods, SMLM methods, TIRF methods, TIRF-SIM methods, TIRF-SMLM methods.

For HILO and TIRF methods, the excitation light is deflected at an angle and imaged through a lens, for example through a tube lens, decentrally into a pupil, hence into the back focal plane, of the illumination objective. In the case of TIRF, the excitation light is guided to one or more points at the edge of the pupil. In the case of HILO, the excitation light is likewise radiated onto the sample at an angle deviating from the normal direction. However, the angles of incidence are not of sufficient magnitude to attain total internal reflection.

The illumination points for TIRF and SIM in the back focal plane of the microscope objective are produced, in a manner that is known in principle, by the or a wavefront modulation device, i.e. by a static grating or by a spatial light modulator, arranged in an intermediate image plane of the illumination beam path.

If the excitation light at the output end of the multimode light guide is no longer fully coherent, interference effects in the sample plane are reduced or minimized. However, if SIM methods are intended to be carried out, the partial coherence of the excitation light that is still present still needs to be of sufficient magnitude to enable the wavefront manipulation device, in particular the phase grating, to still take effective action. When considered over a time period that is much shorter than the exposure time of the camera, the light at the output of the multimode light guide is coherent. The coherence of the light is also manifested in the speckles, in particular. Therefore, SIM is also possible. In contrast to an illumination by means of a single-mode fiber, the multimode light guide itself with optimum collimation supplies an angular spectrum which has the effect that the projected image contaminated as it were by the speckles is distributed over the illumination pattern and is therefore less problematic or no longer problematic at all.

In one particularly preferred exemplary embodiment, at least one device for changing the numerical aperture of the beam of excitation light coupled out of the multimode light guide is present in the illumination beam path. This numerical aperture is also referred to as exit aperture.

The numerical aperture of the light coupled out of the multimode light guide can be influenced by way of the numerical aperture of the light beam of excitation light coupled into the multimode light guide. In one preferred configuration, therefore, the device for changing the numerical exit aperture can comprise a device for changing the numerical aperture of the beam of excitation light coupled into the multimode light guide. This numerical aperture of the light beam coupled into the multimode light guide is also referred to as entrance aperture.

The device for changing the numerical exit aperture can comprise at least one variable optical component. In principle, it is possible for the variable optical component to be arranged at the exit end of the multimode light guide. In one preferred variant, the variable optical component is arranged at the entrance end of the multimode light guide. The variable optical component can advantageously comprise a variable lens group, in particular a zoom optical unit or some other focal length-variable optical unit, or a lens changer.

In principle, it is also possible for the device for changing the numerical exit aperture to comprise a non-variable optical component at the entrance end of the multimode light guide. Supplementarily or alternatively, the device for changing the numerical exit aperture can comprise an optical component arranged at the exit end of the multimode light guide. The optical component can comprise a light-diffracting and/or a refractive component, for example a lens. The optical component can be materially bonded to the output end of the multimode light guide.

In one preferred variant, the optical component is integrally shaped at the output end of the multimode light guide. This can be done by means of a 3D printing method, for example. Supplementarily or alternatively, the output end of the multimode light guide can comprise a ground surface that at least partly provides a lens effect.

In a further variant, the optical component at the output end of the multimode light guide comprises a conical end piece. Such a conical end piece enables the diameter of the exit opening to be changed. The diameter of the conical end piece can either increase in the beam direction, thereby achieving an increase in the size of the exit opening, or it can decrease, thereby achieving a reduction in the size of the exit opening.

The control unit of the microscope can preferably be configured for evaluating the measurement data of the detector, for controlling the variable wavefront modulation device and/or for controlling the device for varying the angle of incidence of the excitation light on the sample, for carrying out at least one of the following methods: SIM methods, SMLM methods, TIRF methods, TIRF-SIM methods, TIRF-SMLM methods.

Further features and advantages of the invention are explained below with reference to the accompanying figures, in which:

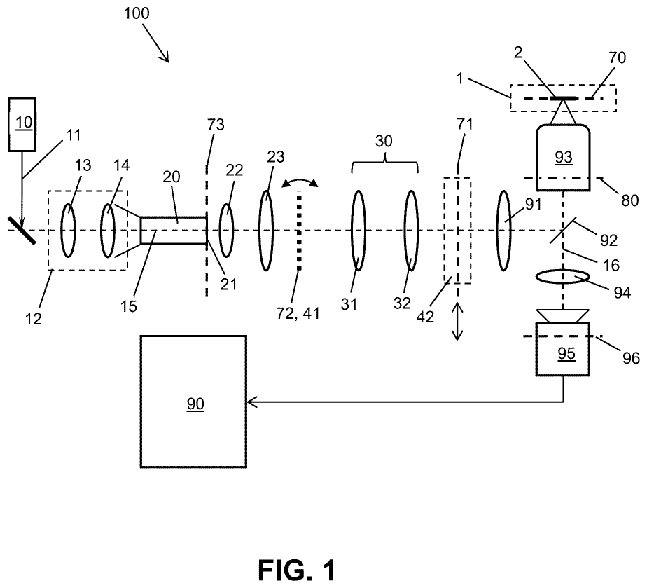

FIG. 1: shows a schematic illustration of a first exemplary embodiment of a microscope according to the invention;

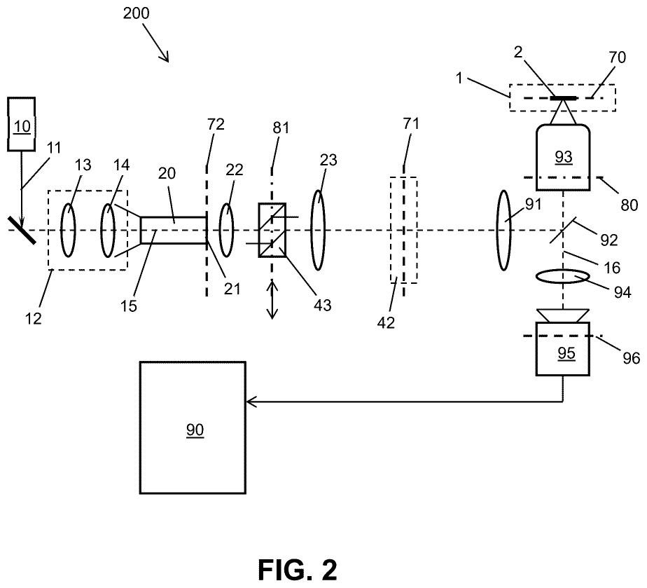

FIG. 2: shows a schematic illustration of a second exemplary embodiment of a microscope according to the invention;

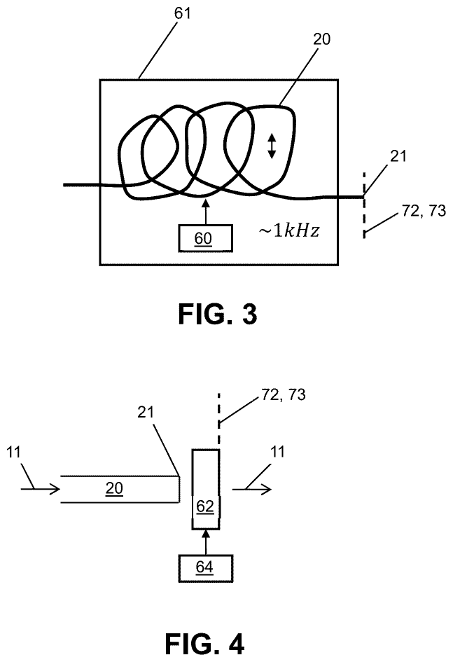

FIG. 3: shows a schematic illustration of one exemplary embodiment of a shaking device for a multimode fiber;

FIG. 4: shows a schematic illustration of an arrangement having a diffuser that is movable in the illumination beam path;

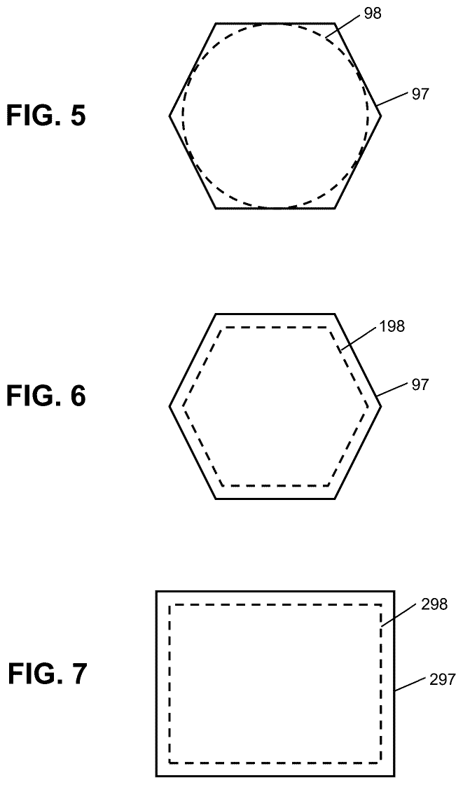

FIG. 5: shows a first example of a sensor area of the detector with an illuminated region of the sample imaged thereon;

FIG. 6: shows a second exemplary embodiment of a sensor area of the detector with an illuminated region of the sample imaged thereon;

FIG. 7: shows a third exemplary embodiment of a sensor area of the detector with an illuminated region of the sample imaged thereon;

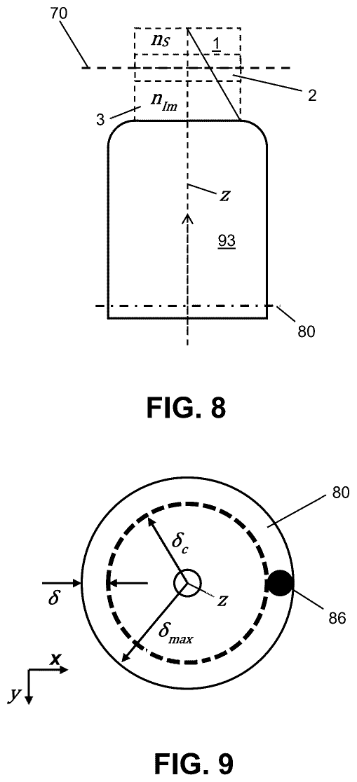

FIG. 8: shows a schematic illustration for elucidating the incidence of the excitation light on the sample;

FIG. 9: shows an illustration of the pupil plane for elucidating the incidence of the excitation light on the sample;

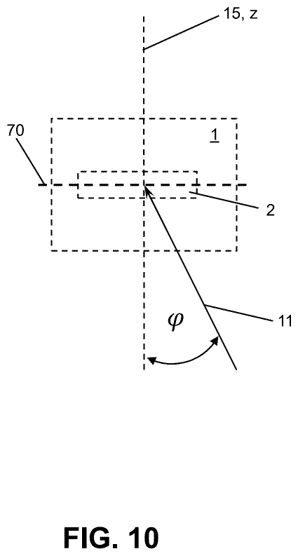

FIG. 10: shows a further schematic illustration for elucidating the incidence of the excitation light on the sample;

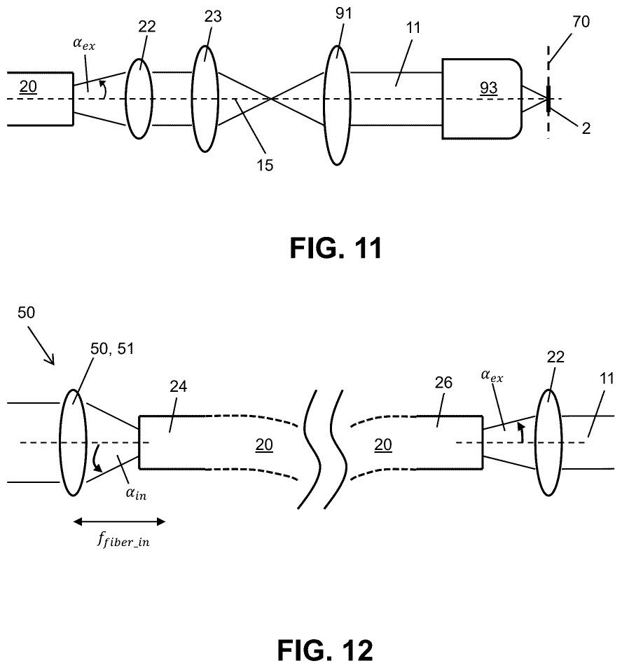

FIG. 11: shows a schematic illustration of a beam of excitation light emerging from the multimode light guide 20, and of downstream optical components;

FIG. 12: shows a schematic illustration of the influencing of the numerical aperture of the beam of excitation light emerging from the multimode light guide by the numerical aperture of the beam of excitation light entering the multimode light guide;

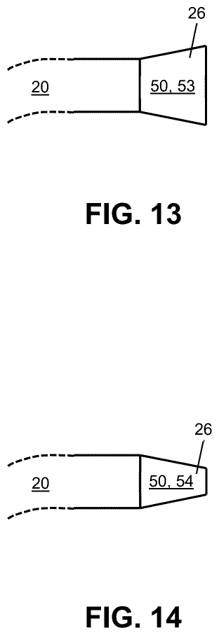

FIG. 13: shows a first example of a device for changing the numerical aperture of the light beam of excitation light coupled out of the multimode light guide; and

FIG. 14: shows a second example of a device for changing the numerical aperture of the light beam of excitation light coupled out of the multimode light guide.

Identical and identically acting components are generally provided with the same reference signs in the figures. A first exemplary embodiment of a microscope 100 according to the invention will be described with reference to FIG. 1. According to the invention, the microscope 100 shown schematically in FIG. 1 comprises firstly a light source 10, for example a laser, for providing excitation light 11 and an illumination beam path for guiding the excitation light 11 into a sample region 1. A sample 2 illustrated schematically is present in the sample region 1. A sample plane is identified by the reference sign 70. In the exemplary embodiment shown, the illumination beam path comprises a variable wavefront manipulation device 42 arranged in an intermediate image plane 71 or in the vicinity of an intermediate image plane 71. In the exemplary embodiment shown, the wavefront manipulation device 42 is intended to be a transmission grating that can be displaced back and forth laterally, that is to say perpendicularly to an optical axis 15, by a drive (not shown). The transmission grating 42 can be a phase grating, in particular. Furthermore, according to the invention, the microscope 100 comprises a two-dimensionally spatially resolving detector 95, for example a CMOS camera, for detecting emission light 16 emitted by the sample 2 in the sample region 1, and a detection beam path having a microscope objective 93 for guiding the emission light 16 onto the detector 95. Finally, the microscope 100 comprises a control unit 90 for evaluating emission light 16 detected by the detector 95. In the exemplary embodiment shown, the control unit 90 is also configured for controlling the drive (not illustrated) for laterally displacing the transmission grating 42. Then according to the invention, for providing an intermediate image plane 73, the illumination beam path comprises at least one relay optical unit 22, 23 and, between the light source 10 and the wavefront manipulation device 42, hence the transmission grating 42, the illumination beam path comprises a multimode light guide 20. According to the invention, an output end 21 of the multimode light guide 20 is arranged in the intermediate image plane 73 or in the vicinity of the intermediate image plane 73

The wavefront manipulation device 42 could alternatively also be realized by a for example reflective and phase-modulating spatial light modulator controlled by the control unit 90.

In detail, the excitation light 11 provided by the light source 10 passes via a beam shaping optical unit 12 having lenses 13 and 14 as a Gaussian mode into the multimode light guide 20, which is intended to be a multimode fiber 20 in the exemplary embodiment shown. According to the invention, the output end 21 of the multimode fiber 20 lies in an intermediate image plane 73 produced by the imaging of an intermediate image plane 72 by lenses 22 and 23. The lenses 22 and 23 form a relay optical unit. The intermediate image plane 72, for its part, is produced by a further relay optical unit 30 formed by lenses 31 and 32. The relay optical unit 30 images an intermediate image plane 71, in which the transmission grating 42 is situated, into the intermediate image plane 72.

In the exemplary embodiment shown, the microscope objective 93 is also part of the illumination beam path. For the purpose of separating illumination light 11 and red-shifted emission light 16, a main beam splitter 92, for example a dichroic beam splitter, is present, at which excitation light 11 is reflected and through which the red-shifted emission light 16 is transmitted in the direction of the detector 95.

The excitation light 11 thus passes via the lenses 22 and 23, via the lenses 31 and 32 and also via a tube lens 91 and the main beam splitter 92 into the microscope objective 93 and is guided, in particular focused, by the latter into the sample plane 70 in the sample 2. The sample plane 70 is imaged through the microscope objective 93 and through the tube lens 91 into the intermediate image plane 71.

Emission light 16 emitted by the sample 2 as a consequence of the irradiation with the excitation light 11 is collected by the microscope objective 93 and guided in the direction of the main beam splitter 92. The emission light 16 then passes through the main beam splitter 92 as intended and is guided by a tube lens 94 in the detection beam path into a sensor plane 96 of the camera 95 and is then detected by the camera 95 in a spatially resolved manner as intended. The measurement data of the camera 95 are evaluated by the control unit 90.

In the exemplary embodiment shown, a pivotable mirror is present in the intermediate image plane 72, which mirror realizes a device for varying an angle of incidence σ of the excitation light 11 on the sample 2 and can be referred to as a TIRF mirror 41. A mechanical drive (not illustrated in FIG. 1) is present for the purpose of pivoting the TIRF mirror 41 in the direction of the curved double-headed arrow, and can be controlled by the control unit 90. In this case, as illustrated in FIG. 10, the angle of incidence σ is measured relative to the optical axis 15, which runs collinearly with the z-axis.

In FIG. 1, the multimode fiber 20 illustrated schematically is intended to have in reality a length of more than 2 m, such that the excitation light 11 is present in a sufficiently homogeneous distribution at the output end 21 of the multimode fiber 20.

Moreover, in the exemplary embodiment, although not illustrated pictorially in FIG. 1, both a sensor area 297 of the detector 95 and a cross-sectional area of the multimode fiber 20 have a rectangular shape and the detection beam path is configured to image an illuminated area in the sample region 1 into the sensor plane 96 of the camera 95 in such a way that a maximum overlap between a sensor region of the camera 95 and the image of the illuminated area in the sample region 1 is attained in the sensor plane 96. This is illustrated in FIG. 7, which shows that an image 298 of a region illuminated by excitation light 11 in the sample region 1 is imaged onto a sensor area 297 of the camera 95 with an accurate fit by the detection beam path. The image 298 of the region illuminated by excitation light 11 substantially corresponds to the cross-sectional area of the multimode fiber 20.

FIG. 5 shows a variant in which the sensor region 97 of the camera 95 has the shape of a regular hexagon and the multimode fiber 20 has a circular cross-section. The detection beam path is configured to image an illuminated area in the sample region 1, which area is likewise circular owing to the circular cross section of the multimode fiber 20, into the sensor plane 96 of the camera 95 in such a way that in the sensor plane 96 a circular image 98 of the illuminated area in the sample region 1 lies completely on the hexagonal sensor region 97 of the camera 95 and a maximum overlap between the circular image 98 of the illuminated area in the sample region 1 and the hexagonal sensor region 97 is attained.

FIG. 6 shows a further variant, which differs from the variant described in association with FIG. 5, in that the multimode fiber 20 has a hexagonal cross-section and hence the image 198 of the illuminated area in the sample region 1 in the sensor plane 96 also has a hexagonal cross-section.

A further exemplary embodiment of a microscope 200 according to the invention will be explained with reference to FIG. 2. Only the differences in comparison with the microscope 100 from FIG. 1 will be explained here.

In contrast to FIG. 1, the relay optical unit 30 is not present in the exemplary embodiment in FIG. 2. That means that the first intermediate image plane 71 is imaged through the lenses 22 and 23 into the intermediate image plane 72, in which the exit end 21 of the multimode fiber 20 is situated.

Instead of the TIRF mirror 41 in FIG. 1, in the exemplary embodiment in FIG. 2, a device 43 for producing a variable lateral beam offset is arranged in a pupil plane 81, which device may be referred to as a TIRF slider and realizes a device for varying the angle of incidence σ of the excitation light 11 on the sample 2. The TIRF slider 43 illustrated schematically can comprise for example a double prism that is positionable laterally variably in the illumination beam path. A mechanical drive (not illustrated in the figure) is present for the purpose of laterally adjusting the laterally variably positionable double prism, and can be controlled by the control unit.

If the intention is to improve the homogeneity of the beam profile at the output 21 of the multimode fiber 20, a device for shaking or vibrating a part of the multimode fiber 20 can be used. This is illustrated schematically in FIG. 3. In this case, a significant part of the multimode fiber 20 is accommodated in a housing 61, in which is situated an actuator 60 mechanically coupled to the multimode fiber 20. At an input end and at an output end of the multimode fiber 20, the latter is held rigidly relative to the housing 61. With the aid of the actuator 60, vibrations can be transmitted to the multimode fiber 20, such that the geometry thereof and thus also the composition of the optical modes currently propagated in each case change. By way of example, the multimode fiber 20 can oscillate back and forth in the direction of the double-headed arrow plotted in FIG. 3. This has the effect of improving the homogeneity of the light distribution at the exit end 21 of the multimode fiber 20. Good results with regard to the homogenization of the light distribution are attained for example if a frequency of the vibrations is of the order of magnitude of 1 KHz.

Alternatively or supplementarily, as illustrated schematically in FIG. 4, a diffuser 62 can be present in the region of the exit end 21 of the multimode fiber 20, and can be caused to oscillate or rotate with the aid of a drive 64, for example a wobbling device and/or a rotating device. A light distribution with very good homogeneity, hence a largely speckle-free light distribution, can thus be achieved at the exit end of the diffuser 62.

Geometric relationships for the suitable positioning of luminous spots in a pupil plane 80 in the back focal plane 80 of the microscope objective 93 will be explained in association with FIGS. 8 and 9.

In this case, FIG. 8 schematically shows the microscope objective 93 with the sample region 1, the sample 2, an immersion liquid 3 and the pupil plane 80, hence the back focal plane of the microscope objective 93. The optical axis of the microscope objective 93 runs collinearly with the z-axis. nₛ denotes the refractive index of the sample 2 and n_{Im} is the refractive index of the immersion liquid 3. FIG. 9 shows a cross-section of the pupil plane 80 with a luminous spot 86. The pupil plane 80 extends in the x-y-plane. The x-, y- and z-axes form a right-handed and rectangular coordinate system. 8 denotes a radial extent of a TIRF region, hence a region in which the TIRF condition is satisfied, in the pupil plane 80. δ_{c} is an inner radius and δₘₐₓ a maximum outer radius of the TIRF region in the pupil plane 80. δ_{c} corresponds to a minimum angle φ_{c} for total internal reflection.

Using the expression that arises from Snell's equations in classical electrodynamics for the critical angle for total internal reflection

$$sin ( {φ}_{c} ) = \frac{{n}_{s}}{{n}_{Im}}$$

with the focal length f_{obj} of the microscope objective 93 and the refractive index n_{Im} of the immersion liquid 3, that yields the minimum radius δ_{c} corresponding to the minimum angle φ_{c} for total internal reflection:

$${δ}_{C} = {f}_{Obj} \cdot {n}_{Im} \cdot sin ( {φ}_{C} )$$

The radial width of the annulus in which the TIRF condition is satisfied is

$$Δ δ = {δ}_{max} - {δ}_{C} ,$$

which with the tube length f_{T}, the numerical aperture NA of the illumination objective and the magnification M of the illumination beam path can be written as:

$$Δ δ = {f}_{Obj} ( N A - {n}_{S} ) = ( {f}_{T} / M ) ( N A - {n}_{S} )$$

Inserting typical values for aqueous samples and typical objectives into this expression yields for Δδ:

$$Δ {δ}_{63 \times 1.46} = ( 164.5 mm / 63 ) ( 1 \text{.46} - 1.335 ) = 326 μm$$

$$Δ {δ}_{100 \times 1.46} = ( 1 64.5 mm / 100 ) ( 1 \text{.46} - 1.335 ) = 206 μm$$

While SMLM methods do not necessarily require spatially coherent light, at least partially coherent light is necessary for SIM since a variable wavefront manipulation device, in particular a static phase grating or a phase grating produced by an SLM, is illuminated and imaged into the sample plane 70. An illumination of the phase grating with excitation light having reduced coherence leads to a reduced axial modulation depth of the structured light and thus to a reduced axial resolution capability. If a flat-top illumination is used at an SIM microscope, the beam shaping is therefore not permitted to totally destroy the spatial coherence. In order that the light of the different orders of diffraction used can interfere in the sample plane 70, the phase grating must be illuminated with linearly polarized light. Coherent illumination light leads to interference effects in the illumination field.

For TIRF, the beam diameter of the excitation light in the objective pupil 80 of the microscope objective 93 should be small in order that the TIRF condition is satisfied for all portions of the excitation light 11. In the case of critical illumination with a multimode fiber, there is a trade-off between an achievable field of view (FOV) and a spot size in the objective pupil 80.

In order to realize the TIRF condition and a sufficiently large FOV (FOV=field of view) in the illumination, it is advantageous if the relay optical units satisfy the following conditions. Firstly, a beam diameter d_{BeamPupil} of the excitation light 11 in the pupil 80 of the microscope objective 93 should be smaller than a value to be defined, in order that the TIRF condition is satisfied. A lateral dimension of the FOV in the sample plane should then encompass a minimum size to be defined. The size of the FOV may be motivated for example by an FOV at an existing system in the SIM mode. These values emerge from the following considerations: In order to satisfy the TIRF condition, firstly

$$Δ δ > {d}_{BeamPupil}$$

should be realized.

Preferred embodiments of the invention exploit the property of multimode light guides, in particular multimode fibers, that to a specific extent the numerical aperture of the light coupled out can be influenced by way of the numerical aperture of the light coupled in. This property can be used to realize for example a TIRF microscope having a large field of view shaped by the multimode fiber. This will be explained below. For high resolution microscopes that are intended to be used to realize SIM, SMLM with TIRF, the achievable FOV should be as large as possible. If the output end of the multimode light guide 20 is imaged into the sample plane, then with the numerical aperture NA_{fiber} of the light at the end of the multimode light guide 20, in particular a multimode fiber, the focal length f_{TL} of the tube lens 91, the focal length f_{KL} of the lens 22, the focal length f_{obj} of the illumination objective 93 and the focal length fₓ of the relay lens 23, the following conditions are obtained which characterize a trade-off between the beam diameter in the pupil and the FOV of the illumination:

$${d}_{BeamPupil} = 2 \cdot {d}_{afterKL} \frac{{f}_{TL}}{{f}_{X}} = 2 \cdot N {A}_{fiber} \cdot {f}_{KL} \cdot \frac{{f}_{TL}}{{f}_{X}} \qquad Formula 1$$

$$F O {V}_{ill} = {d}_{afterX} / M = {d}_{afterX} \cdot \frac{{f}_{Obj}}{{f}_{TL}} = {d}_{fiber} \cdot \frac{{f}_{X}}{{f}_{KL}} \cdot \frac{{f}_{Obj}}{{f}_{TL}} \qquad Formula 2$$

where:
d_{afterKL} diameter of the illumination beam directly downstream of, i.e. after, the lens 22
d_{afterX} diameter of the illumination beam directly downstream of, i.e. after, the relay lens 23
d_{BeamPupil} beam diameter of the excitation light 11 in the pupil 80 of the illumination objective 93
d_{fiber} diameter of the multimode light guide 20 at the exit end 26 focal length of the lens 22
f_{obj} focal length of the illumination objective 93
f_{TL} focal length of the tube lens 91
fₓ focal length of the relay lens 23
F_{OVill} field of view of the illumination=lateral dimension of the illuminated region in the sample plane
M magnification M of the illumination beam path
NA_{fiber} numerical aperture of the illumination beam after coupling out of the multimode light guide

For the correct functioning of SIM, it is preferred for the light points of the 0 and +/−1st orders of diffraction in the objective pupil for realizing the SIM illumination not to be too large. Excessively large and not fully coherent illumination spots in the objective pupil have the effect that the depth of the z-modulation of the resulting interference pattern decreases. FIG. 11 schematically shows as angle αₑₓ the numerical aperture of the beam of excitation light 11 exiting from the multimode light guide 20. Assuming that the refractive index is 1, the numerical aperture results mathematically as

$$N {A}_{fiber \_ ex} = N {A}_{fiber} = sin ( {α}_{ex} )$$

NA_{fiber_ex} by way of NA_{fiber_in} thus means that the numerical aperture of the light beam of the excitation light 11 coupled into the multimode light guide 20 can be controlled in such a way that SIM/SMLM+TIRF with a large FOVᵢₗₗ is possible. As described above, control of the NA_{fiber_in} of the excitation light 11 coupled in makes it possible to selectively excite modes in the multimode light guide 20. This has the effect that the excitation light 11 coupled out of the multimode light guide 20 exhibits a smaller NA_{fiber_ex} than the multimode light guide 20 can support per se. As a result of coupling in excitation light 11 with a NA_{fiber_in} which is smaller than the numerical aperture of the multimode light guide 20, not all modes which are possible or are supported in the multimode light guide 20 are excited. The number of excited modes determines the speckle size in the beam profile at the output of the multimode light guide 20. In order to achieve a homogeneous illumination, a certain minimum number of modes must be excited. Therefore, NA_{fiber_in} during the input coupling cannot be chosen to be arbitrarily small. The number of supported modes in the multimode light guide 20 additionally depends on the geometry of the multimode light guide 20, in particular on the shape and size thereof. Consequently, the minimum possible NA_{fiber_in} also depends on the geometry of the multimode light guide 20.

FIG. 12 schematically illustrates that the angle αₑₓ and thus the numerical aperture NA_{fiber_ex} of the beam of excitation light 11 exiting from the exit end 26 of the multimode light guide 20 can be influenced by the numerical aperture NA_{fiber_in} of the light beam of excitation light 11 entering the entrance end 24 of the multimode light guide 20. FIG. 12 shows the angles αₑₓ and αᵢₙ. Assuming that the refractive index is 1, the numerical apertures are given mathematically in each case by the sine of the respective angle, i.e. by NA_{fiber_ex}=sin (αₑₓ) and NA_{fiber_in}=sin (αᵢₙ). NA_{fiber_in} can be controlled for a given source, hence for a given beam size and a given initial value of the beam divergence, by way of the focal length f_{fiber_in} for coupling in the excitation light 11 of a used lens 51 upstream of the fiber. The lens 51 is part of a device 50 for changing the numerical aperture NA_{fiber_ex} of the light beam of excitation light 11 coupled out of the multimode light guide 20. The lens 51 can be part of a focal length-variable optical unit, for example a zoom optical unit, or else part of a lens changing device, by means of which the focal length f_{fiber_in} and thus the angle αᵢₙ and NA_{fiber_in} and finally NA_{fiber_ex} can be changed as desired. In particular, NA_{fiber_ex} can be reduced in order to reduce the beam diameter, as given in Formula (1), and in order thus to satisfy the TIRF condition more easily.

FIGS. 13 and 14 show variants in which the device 50 for changing the numerical aperture NA_{fiber_ex} of the light beam of excitation light 11 coupled out of the multimode light guide 20 is realized by a conical end piece materially bonded to the multimode light guide 20. In FIG. 13, the diameter increases in the beam direction, i.e. a larger diameter in comparison with the rest of the multimode light guide 20 is realized at the exit end 26. Accordingly, NA_{fiber_ex} is reduced. In FIG. 14, the diameter decreases in the beam direction, i.e. at the exit end 26 the diameter of the multimode light guide 20 is reduced in comparison with the rest of the multimode light guide 20. Accordingly, NA_{fiber_ex} is increased. In this way, too, as shown by Formula 2 indicated above, it is possible to influence the field size FOVᵢₗₗ in the sample.

This invention presents a novel microscope for high-resolution laser wide-field microscopy with flat-top illumination. What is essential here is that an exit end of a multimode light guide, in particular a multimode fiber, having a preferably rectangular or polygonal cross-section is critically imaged into a sample plane via relay optical units. An intermediate image plane is produced by at least one relay optical unit. The microscope can be in particular a fluorescence wide-field microscope with additional devices for realizing SMLM methods and/or SIM methods. Optionally, a Hilo/TIRF illumination can additionally be realized.

### LIST OF REFERENCE SIGNS

1 sample region
2 sample
3 immersion liquid
10 light source, e.g. laser, LED
11 excitation light
12 beam shaping optical unit
13 first lens of beam shaping optical unit 12
14 second lens of beam shaping optical unit 12
15 optical axis, parallel to the z-axis
16 emission light, e.g. fluorescent light
20 multimode light guide, e.g. multimode fiber
21 output end of multimode light guide 20
22 collimation lens, forms relay optical unit with lens 23
23 lens, forms relay optical unit with collimation lens 22
24 entrance end or input opening of the multimode light guide 20
26 output end or exit opening of the multimode light guide 20
30 relay optical unit
31 first lens of relay optical unit 30
32 first lens of relay optical unit 30
41 device for varying angle of incidence σ of the excitation light 11 on sample 2, pivotable mirror or pivotable glass plate in intermediate image plane 72, TIRF mirror
42 wavefront manipulation device, e.g. grating, SLM
43 device for varying angle of incidence σ of the excitation light 11 on sample 2, laterally displaceable double prism in pupil plane 81, TIRF slider
50 device for changing the numerical aperture NA_{fiber_ex} of the light beam of excitation light 11 coupled out of the multimode light guide 20
51 lens, for example part of a zoom optical unit for changing the numerical aperture NA_{fiber_in} of the light beam of excitation light 11 coupled into the multimode light guide 20
53 optical component, conical element, forms exit end 26 of the multimode light guide 20
54 optical component, conical element, forms exit end 26 of the multimode light guide 20
60 device for shaking or vibrating the multimode light guide 20
61 housing of device 60
62 diffuser in the illumination beam path, e.g. wobble plate
64 drive for diffuser 62, e.g. wobbling device
70 plane in sample region 1, plane in sample 2
71 intermediate image plane, first intermediate image plane
72 intermediate image plane, second intermediate image plane
73 intermediate image plane, third intermediate image plane
80 back focal plane of the microscope objective 93, pupil
81 pupil plane
86 luminous spot in pupil 80
90 control unit, e.g. PC
91 tube lens in illumination beam path
92 main beam splitter
93 microscope objective, illumination objective
94 tube lens in detection beam path
95 detector, e.g. camera
96 sensor plane of the detector 95
97 sensor area of detector
98 illuminated region of the sample 2 that is imaged onto sensor area 97 of detector 95, corresponds to cross-sectional area of multimode light guide 20
100 microscope according to the invention
198 illuminated region of the sample 2 that is imaged onto sensor area 97 of detector 95, corresponds to cross-sectional area of multimode light guide 20
200 microscope according to the invention
297 sensor area of detector 95
298 illuminated region of the sample 2 that is imaged onto sensor area 297 of detector 95, corresponds to cross-sectional area of multimode light guide 20
d_{afterKL} diameter of the illumination beam directly downstream of, i.e. after, the lens 22
d_{afterx} diameter of the illumination beam directly downstream of, i.e. after, the relay lens 23
d_{BeamPupil} beam diameter of excitation light 11 in pupil 80 of the illumination objective 93
d_{fiber} diameter of the multimode light guide 20 at the exit end 26
n_{Im} refractive index of immersion liquid 3
nₛ refractive index of the sample 2
f_{fiber_in} focal length of the lens 51 upstream of the input opening of the multimode light guide 20
f_{KL} focal length of the lens 22
f_{obj} focal length of the illumination objective 93
f_{T} tube length
f_{TL} focal length of the tube lens 91
fₓ focal length of the relay lens 23
FOVᵢₗₗ field of view of the illumination=lateral dimension of the illuminated region in the sample plane
M magnification of the illumination beam path
NA numerical aperture of the microscope objective 93
NA_{fiber} numerical aperture of the multimode light guide 20, e.g. of the multimode fiber 20
NA_{fiber_ex} numerical aperture of the light beam of excitation light 11 coupled out of the multimode light guide 20, numerical exit aperture
NA_{fiber_in} numerical aperture of the light beam of excitation light 11 coupled into the multimode light guide 20, numerical entrance aperture
x, y, Z right-handed rectangular coordinate system
αₑₓ aperture angle of the light beam of excitation light coupled into the multimode light guide 20
αᵢₙ aperture angle of the light beam of excitation light coupled into the multimode light guide 20
δ radial extent of TIRF region in pupil plane 80
δ_{c} inner radius of the TIRF region in pupil plane 80
δₘₐₓ outer radius of the TIRF region in pupil plane 80
Δδ radial width of the annulus in which TIRF condition is satisfied
φ angle of incidence of the excitation light 11 on sample 2
Φ_{c} minimum angle for total internal reflection, critical angle for total internal reflection, corresponds to radius δ_{c} in objective pupil 80

### REFERENCES

[1] DE10 2022 103 051 A1
[2] https://www.edmundoptics.de/c/light-pipes-homogenizing-rods/697/
[3] https://www.molex.com/en-us/products/optical-solutions/optical-fiber/de-speckler-system
[Salter] Patrick S. Salter and Martin J. Booth, Adaptive optics in laser processing, Light Science and Application 8:110 (2019)
[Nakata] Yoshiki Nakata, Kazuhito Osawa, Noriaki Miyanaga, Utilization of the high spatial frequency component in adaptive beam shaping by using a virtual diagonal phase grating. Scientific Reports 9:4640 (2019)
[Jesacher] A. Jesacher, et al., Near-perfect hologram reconstruction with a spatial light modulator. OPTICS EXPRESS 2597, 16, 4 (2008)
[Schmidt] S. Schmidt, et al., Tailored micro-optical freeform holograms for integrated complex beam shaping. Optica 1279, 7, 10 (2020)
[Printoptix] https://www.printoptix.com/
[Plidschun] Malte Plidschun et al., Fiber-based 3D nano-printed holography with individually phase-engineered remote points. Scientific Reports 12:20920 (2022)
[Stehr] Florian Stehr, et al., Flat-top TIRF illumination boosts DNA-PAINT imaging and quantification. Nature Communications 10:1268 (2019)
[Khaw] Ian Khaw, et al., Flat-field illumination for quantitative fluorescence imaging. Optics Express 26, 12 (2018)
[Lamm] Jeff Y. L. Lamm, et al., An economic, square-shaped flat-field illumination module for TIRF-based superresolution microscopy. Biophysical Reports 2, 100044 (2022)
[Gustafsson] Mats G. L. Gustafsson, et al., Three-Dimensional Resolution Doubling in Wide-Field Fluorescence Microscopy by Structured Illumination. Biophysical Journal 94, 4957-4970 (2008)
[Kwakwa] Kwasi Kwakwa, et al., easySTORM: a robust, lower-cost approach to localization and TIRF microscopy. J. Biophotonics 9, No. 9, 948-957 (2016)
[Ries] Daniel Schröder, et al., Cost-efficient open source laser engine for Microscopy. OPTICS EXPRESS 11, 2, 609 (2020)
[Zhao] Zeyu Zhao, et al., High-power homogeneous illumination for super-resolution localization microscopy with large field-of-view. OPTICS EXPRESS 25, 12, 13395 (2017)
[Cizmar] Cizmar, Tomas et al., Seeing through the chaos in multimode fibers.
[Farley] K. Farley, et al., Optical fiber designs for beam shaping. SPIE: Fiber Lasers XI: Technology, Systems, and Applications 2014

1. A microscope comprising:
light source for providing excitation light,
an illumination beam path for guiding the excitation light into a sample region,
a two-dimensionally spatially resolving detector for detecting emission light emitted by a sample in the sample region,
a detection beam path having a microscope objective for guiding the emission light onto the detector, and
a control unit for evaluating emission light detected by the detector,
wherein
the illumination beam path, for providing an intermediate image plane, comprises at least one relay optical unit,
the illumination beam path comprises a multimode light guide,
an output end of the multimode light guide is arranged in the intermediate image plane or in a vicinity of the intermediate image plane, and
the illumination beam path comprises a variable wavefront manipulation device arranged in an intermediate image plane or in a vicinity of the intermediate image plane.

2. The microscope as claimed in claim 1,
wherein
the multimode light guide comprises at least one multimode fiber or at least one multimode light guiding rod.

3. (canceled)

4. The microscope as claimed in claim 1,
wherein
the variable wavefront manipulation device comprises at least one of the following components: a spatial light manipulator, diffractive component, laterally displaceable transmission grating, laterally displaceable reflection grating, refractive component.

5. The microscope as claimed in claim 2,
wherein a length of the multimode fiber is more than 2 meters.

6. The microscope as claimed in claim 2,
wherein
the illumination beam path comprises a device for mechanically manipulating the multimode fiber).

7. The microscope as claimed in claim 1,
wherein
the illumination beam path comprises a diffuser.

8. The microscope as claimed in claim 7,
further comprising a device for moving the diffuser,
wherein the device for moving the diffuser comprises a wobbling device and/or a rotating device.

9. (canceled)

10. The microscope as claimed in claim 1,
wherein the multimode light guide has a circular cross-section, or
wherein a cross-section of the multimode light guide has a shape of a polygon, a rectangular shape, or a square shape.

11. (canceled)

12. The microscope as claimed in claim 1,
wherein
both a sensor area of the detector and a cross-sectional area of the multimode light guide each have a polygon shape.

13. The microscope as claimed in claim 1,
wherein
the detection beam path is configured to image an illuminated area in the sample region into a sensor plane of the camera in such a way that a maximum overlap between a sensor region of the camera and the image of the illuminated area in the sample region is attained in the sensor plane.

14. The microscope as claimed in claim 1,
wherein
the illumination beam path comprises a device for varying an angle of incidence of the excitation light on the sample.

15. The microscope as claimed in claim 14,
wherein
the device for varying the angle of incidence of the excitation light comprises a pivotable mirror or a pivotable plane-parallel glass plate, said mirror or said plate being arranged in an intermediate image plane or in the vicinity of the intermediate image plane of the illumination beam path.

16. The microscope as claimed in claim 14,
wherein
the device for varying the angle of incidence of the excitation light comprises a device for producing a variable lateral beam offset, said device being arranged in a pupil plane or in a vicinity of a pupil plane of the illumination beam path.

17. The microscope as claimed in claim 1,
wherein
the control device is configured
for evaluating the measurement data of the detector and/or
for controlling the variable wavefront modulation device and/or
for controlling the device for varying the angle of incidence of the excitation light on the sample,
for carrying out at least one of the following methods
SIM methods,
SMLM methods,
TIRF methods,
TIRF-SIM methods,
TIRF-SMLM methods.

18. The microscope as claimed in claim 1,
wherein
at least one device for changing the numerical exit aperture of the beam of excitation light coupled out of the multimode light guide is present in the illumination beam path.

19. The microscope as claimed in claim 18,
wherein the device for changing the numerical exit aperture comprises a device for changing the numerical entrance aperture of the beam of excitation light coupled into the multimode light guide.

20. The microscope as claimed in claim 18,
wherein
the device for changing the numerical exit aperture comprises at least one variable optical component arranged at an entrance end of the multimode light guide.

21. (canceled)

22. The microscope as claimed in claim 19,
wherein
the device for changing the numerical exit aperture comprises an optical component which is arranged at an exit end of the multimode light guide.

23. The microscope as claimed in claim 22,
wherein
the optical component is a lens or comprises a lens.

24. The microscope as claimed in claim 22,
wherein
the optical component at the output end of the multimode light guide comprises a conical end piece.

25. A method for microscopy in which the following method steps are carried out:
guiding excitation light from a light source via an illumination beam path onto a sample,
guiding emission light emitted by the sample via a detection beam path having a microscope objective onto a two-dimensionally spatially resolving detector, and
detecting the emission light with the detector,
wherein
an intensity distribution of the excitation light over a beam cross-section of the excitation light is homogenized by excitation light provided by the light source being guided via a multimode light guide in the illumination beam path, an output end of the multimode light guide being arranged in an intermediate image plane or in a vicinity of the intermediate image plane, and
the excitation light is manipulated by a variable wavefront manipulation device arranged in the illumination beam path in an intermediate image plane or in a vicinity of the intermediate image plane.

26. The method as claimed in claim 25,
wherein
at least one part of the multimode fiber is moved back and forth in the illumination beam path.

27. The method as claimed in claim 25,
wherein
at least one part of the multimode fiber is shaken or excited to effect vibrations in the illumination beam path.

28. The method as claimed in claim 26,
wherein
a frequency of the movement of a part of the multimode fiber is greater than 500 Hz.

29-31. (canceled)
